(19) United States
(12) Patent Application Publication
(10) Pub. No.: US 2009/0093299 A1
(43) Pub. Date: Apr. 9, 2009

(54) RECENT RESULT DISPLAY INDICIA FOR GAMING DEVICE

(75) Inventor: John F. Acres, Corvallis, OR (US)

Correspondence Address: MARGER JOHNSON & MCCOLLOM, P.C., 210 SW MORRISON STREET, SUITE 400, PORTLAND, OR, 97204, US

(73) Assignee: ACRES-FIORE, INC., Las Vegas, NV (US)

(21) Appl. No.: 12/332,614

(22) Filed: Dec. 11, 2008

Related U.S. Application Data
(63) Continuation-in-part of application No. 12/037,295, filed on Feb. 26, 2008.
Application No. 12/037,295 is a continuation-in-part of application No. PCT/US2007/000417, filed on Jan. 4, 2007.
Application No. PCT/US2007/000417 is a continuation-in-part of application No. 11/331,716, filed on Jan. 13, 2006.

(51) Int. Cl. G06F 17/00

(52) U.S. Cl. 463/20; 463/25

(57) ABSTRACT

A gaming device comprising a base game, a base game pay table, and at least one bonus award mechanism configured to award a bonus award in addition to any award resulting from the base game pay table. The gaming device further includes a first win proximity indicator configured to provide an indication of the change in likelihood of awarding the bonus award, and a display configured to provide a first indicia of a previous win of the bonus award together with the first win proximity indicator. Multiple indicators from multiple previous wins may be displayed in spatial relationship to one another along a meter to provide a player with further statistical information about possible winning trigger thresholds.

### CROSS-REFERENCE TO RELATED APPLICATION

This application is a continuation-in-part of U.S. patent application Ser. No. 12/037,295, filed Feb. 26, 2008, which itself is a continuation-in-part of prior applications U.S. patent application Ser. No. 11/331,716, filed Jan. 13, 2006, and International Application No. PCT/US2007/000417, filed Jan. 4, 2007. The contents of all the foregoing applications are hereby incorporated herein for all purposes.

### BACKGROUND OF THE INVENTION

1. Field of the Invention

This invention relates to novel methods of presenting multi-level mystery bonus awards on games of chance.

2. Description of the Prior Art

Playing games of chance is a popular recreational activity. There are many types of games of chance including table games where players wager against a live dealer such as blackjack, Pai Gow, roulette, Baccarat. Other types of games of chance are offered as automated machines. Examples include slots, poker, bingo, etc. Still other types of games of chance allow players to wager against one another, such as a poker table. In return for a wager, games of chance generate randomly determined outcomes, some of which result in a winning event. Games of chance are often played with wagers having financial value but some games of chance are played with points or other freely available currency having no fiscal worth.

Games of chance may be played in casinos, or at home using electronic devices or mechanical equipment. Gambling via Internet, whether for fun or for money, is also a popular activity.

Games of chance typically associate a winning event with a specific game outcome. For example, achievement of BAR BAR BAR on the payline of a three reel slot machine might pay 20 credits on a 1 credit wager. To increase player interest, bonus awards which are won independently of any single game outcome are sometimes offered. The “mystery” bonus is a popular bonus award that is so named because players cannot easily discern why the award occurred, as it is completely independent of the game's normal schedule of payments.

Games may be made more attractive by giving players a sense of anticipation that a win is close at hand. Players might be more willing to play if they believe their odds of winning such an award increase with every play. In the case of a mystery bonus, credits played are tracked across a single machine or bank of machines and a bonus given to the player that causes the cumulative credits played to exceed a pre-established threshold. Once won, a new threshold is established, typically between a high and low value, and the accumulation of play credits is started again.

Since the threshold is pre-established at the start of play, the gaming machine and/or network has foreknowledge about the proximity of the player or players to winning the mystery bonus. As a result, it is possible for the gaming machine to provide visual and/or audible cues to the player to indicate their proximity to the threshold and, thus, to winning the bonus. Such cues are described in co-pending U.S. patent application Ser. No. 12/037,295, the contents of which are incorporated herein in their entirety.

A casino gains the most benefit by encouraging players to play and keep playing. Configuring a gaming machine to provide cues to win proximity is just one aspect to encouraging players to keep playing.

Accordingly, the need exists for other manipulations of the gaming machine that increase user interest in maintaining play on the gaming machine.

### SUMMARY OF THE INVENTION

The invention is a device and method which improves the player appeal of mystery bonus awards. Each play of a base game increases the likelihood of winning a bonus award. A display or other device provides a graphical indication, or more generally a cue, indicating the change in likelihood of winning the bonus award—i.e. a win proximity indicator. In one aspect of the invention, a gaming machine or system tracks historical data on win proximity and displays its relationship to a currently-tracked win proximity. The invention is thus intended to encourage a player to keep playing if given some historical data on win proximity so that the player may compare his or her present win proximity to those that have resulted in awards from the past.

A gaming device constructed according to embodiments of the invention include a bonus game with a number generator configured to select multiple trigger thresholds over time, including a present trigger threshold and at least one past trigger threshold. At least one bonus award mechanism is configured to award a bonus award, and at least one counter is configured to generate a count related to the occurrence of wagers that bear a defined relationship to a determined value. The counter is operatively connected to the bonus award mechanism and configured to award a bonus award when the count bears a predetermined relationship to the present trigger threshold. A display is configured to provide a graphical indication of the change in likelihood of awarding the bonus award and provide a graphical indication of the relationship of the past trigger threshold to the change in likelihood of awarding the bonus award.

In another aspect, a gaming device implemented according to the invention comprises a base game, a base game pay table, and at least one bonus award mechanism configured to award a bonus award in addition to any award resulting from the base game pay table. The gaming device further includes a first win proximity indicator configured to provide an indication of the change in likelihood of awarding the bonus award, and a display configured to provide a first indicia of a previous win of the bonus award together with the first win proximity indicator. Multiple indicators from multiple previous wins may be displayed in spatial relationship to one another along a meter to provide a player with further statistical information about possible winning trigger thresholds.

A method for operating a gaming device according to the invention comprises selecting at least two trigger thresholds including a first past trigger threshold and a current trigger threshold. At least one count, related to the occurrence of wagers, is then generated and the count compared to the current trigger threshold. The method then indicates the proximity of the count to the current trigger threshold and to the first past trigger threshold and awards a bonus award when the count substantially meets the current trigger threshold.

In one embodiment, the graphical indication takes the form of a proximity indicator such as a bar with defined minimum and maximum points showing the boundaries of possible win thresholds. Indicia such as a pointer moves dynamically along the bar as the win proximity increases. When the win threshold is met, the bonus is awarded, and that place along the proximity indicator bar at which the pointer was located is tagged with a second indicia indicating a past win. Several such past wins can be simultaneously displayed along the proximity indicator bar to give the player a statistical indication of were wins have occurred in the past, and thus some indication of where wins might occur in the future.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1a is a prior art flow chart for initializing a progressive mystery bonus award.

FIG. 1b is a flow chart for implementing a progressive mystery bonus award.

FIG. 2 illustrates a prior art four-level progressive mystery award display.

FIG. 3 is a flow chart of a preferred implementation of the progressive mystery award.

FIG. 4 illustrates a four-level progressive mystery award using a video-based wheel indicator.

FIG. 5 illustrates an eight-level fixed-award mystery award using a video based wheel indicator, winner identifier and win indicator.

FIG. 6 illustrates a 22-level fixed award mystery award using a mechanical wheel indicator with illuminated indications of proximity to the next mystery award win, and illuminated indicator of wager size.

FIG. 7 illustrates a 16-level fixed-award mystery award with an additional progressive mystery award which includes illuminators to indicate proximity to next award occurrence.

FIG. 8 is a schematic diagram of gaming machines and display device connected to a mystery award controller.

FIG. 9 is a schematic diagram of a video subsystem used as a display device according to the invention.

FIG. 10 is a schematic diagram of a motorized wheel, mystery award proximity indicator and wager size indicator used as a display device according to the invention.

FIG. 11 is a front view of game similar to the one depicted in FIG. 6.

FIG. 12 is an enlarged view of a screen in the view of FIG. 11.

FIGS. 13-16 are views of the screen of FIG. 12 in different stages of game play with

FIG. 17 is a highly schematic diagram of selected components of the game of FIG. 11.

FIGS. 18-19 are schematic diagrams of a portion of the circuitry for controlling lights and displays on the game of FIG. 11.

FIGS. 20-22 are flow charts that depict the behavior of lights on the game of FIG. 11 during different modes of operation according to features of the invention.

FIG. 23 illustrates an embodiment of the invention to indicate multiple last win indicia.

FIG. 24 is a chart showing mystery bonus counts and awards tracked over time in connection with the multiple last win indicia of FIG. 23.

### DETAILED DESCRIPTION OF THE INVENTION

Though the invention is equally useful with table games and gaming machines, the following discussion describes its use with gaming machines only. I do this solely for clarity of explanation as the manner of operation on any game of chance—table game or gaming machine—is very similar and the claims regarding this invention should in no way be limited by this clarification. The invention is also useful in Internet gambling and computer games that simulate wagering.

“Mystery bonus” is defined herein as a system that selects awards as a function of game play events, excluding specific individual game outcomes. The definition of a mystery bonus does not include an award that is paid simply because a single gaming machine outcome resulted in a specific result, such as BAR BAR BAR on a three reel slot machine, as that is a normal jackpot occurrence. A mystery bonus could be, however, paid on the 11^{th} occurrence of BAR BAR BAR. It will be appreciated by one of skill in the art that there are many methods and techniques for determining when a mystery award occurs. Although I may choose to describe a particular embodiment while teaching how the invention functions, I do not limit the claims of the invention to only that embodiment.

In addition, the winner does not have to be the person whose game play caused the winning condition to be met. The award could be paid to the tenth person that makes a wager after the win occurs, the person that placed the wager prior to the wager that met the winning condition, etc. One of ordinary skill will recognize that many such variations are possible and may be used with the invention.

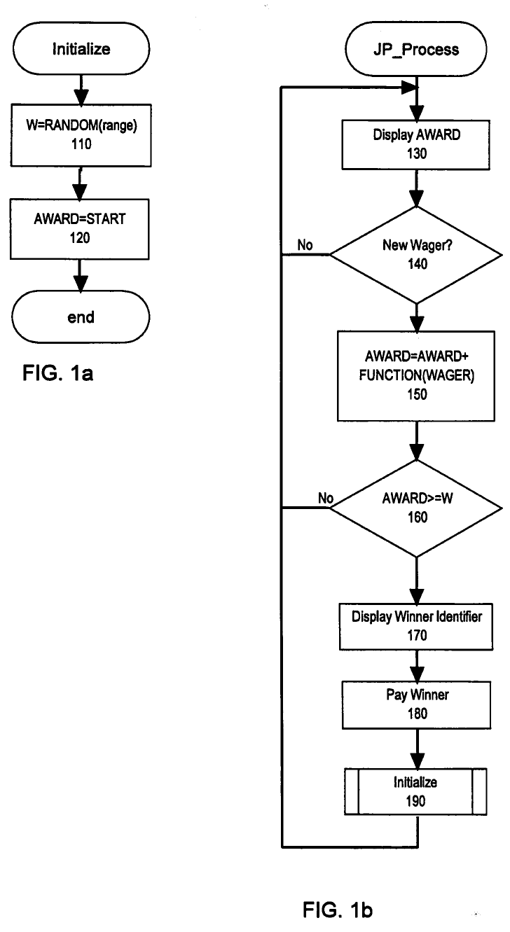

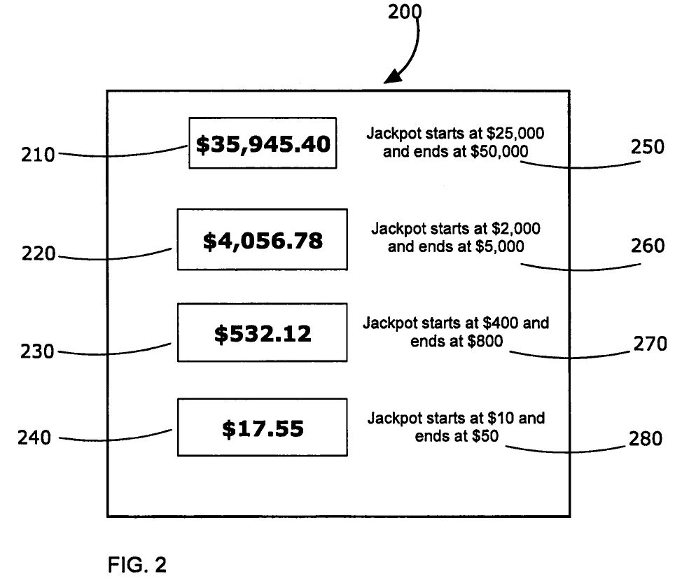

Mystery bonuses are awarded as a function of game play and are increasingly likely to be won with each game played. FIG. 1a, FIG. 1b, and FIG. 2 are indicative of prior art mystery bonus award operation. Here the mystery award is a progressive amount because it grows in value as a function of each wager made until it is won. Once won, the award is initialized to a starting value and the process begins again. FIG. 1a depicts the initialization procedure which is executed once upon inception of the mystery award and executed again after each winning occurrence of the mystery award.

A mystery progressive award is defined by a starting and ending (maximum) value. The award must be won before the award grows larger than the maximum value. A winning number W is randomly selected from within the range of all numbers between the starting and ending award values. For example, a mystery progressive starts at $1,000.00 and ends at $5,000.00. A winning value W is chosen, at 110 of FIG. 1a, from the range numbers between $1,000.00 and $5,000.00. In this example, W=$2,431.56. The progressive award value is set to the starting value of the award range 120—which is $1,000.00—and the bonus is ready for play as depicted in FIG. 1b.

The current award value—$1,000.00—is displayed to players 130 and then a new wager is awaited 140. When a wager occurs, the award value is increased as a function of the wager size 150. A commonly used embodiment adds a percentage of each wager amount to AWARD. For example, AWARD=$ 1,000.00, a wager of $3.00 is made, and FUNCTION is 3% of wager size. AWARD now grows to $1,000.09, as 3% of $3 is 9 cents ($0.09). AWARD is then tested against W at step 160. Since $1,000.09 is less than $2,431.56, the test fails and the flow chart returns to step 130.

This process continues until cumulative play brings AWARD=$2,431.56, making comparison 160 true and the flow chart passes to step 170 where the winner is identified. The winner in this case is the person whose wager caused AWARD to grow equal to W. The winner is then paid the amount won, $2,431.56 at step 180, after which the mystery award is again initialized 190, which simply executes the steps of FIG. 1a again, and the process repeats.

A fixed award mystery bonus works exactly like the progressive mystery bonus award just described, except at step 180, the winner is paid the fixed amount—100 credits for example—instead of the incremented AWARD amount.

FIG. 2 is a prior art four-level progressive mystery bonus display. Enclosure 200 houses the displays and may be configured as an overhead sign, built into the gaming machine, or both. Each display, 210, 220, 230 and 240, represents one progressive mystery bonus award and each grows as a function of wagers made in any gaming machine linked to these awards. Each of the four award values has a winning number W chosen for it during initialization and each award is won independently of the others.

The range for each progressive award 250, 260, 270, and 280 are made known to players so they may understand that, as each progressive award grows, it is more likely to be won.

When one of the mystery awards is won, the winning display immediately begins to alternate every few seconds between the progressive bonus amount won and the winning machine identifier. After the award amount is paid to the winner, either automatically as credits placed on the winning machine or as a manual payment of cash or check directly to the player, the won mystery progressive award is reset to its starting value and again grows as wagers are made in the associated games of chance.

In another embodiment of the prior art, a light or other indicator is placed on, or near each machine in the link. When a win occurs, the winning machine indicator is activated, and remains active, until the award is paid. Because there are so many numbers, multi-level mystery progressives are confusing to many players and this limits their appeal. While the growing award amount, and the corresponding increased likelihood that a win will occur, creates drama and therefore enhances entertainment value to the player, the win occurrence itself is anticlimactic to everyone but the winner because the amount won is known the instant the win occurs.

Effectiveness of multi-level mystery bonus awards is limited by the confusion of displaying multiple bonus award values and player enjoyment would increase if such displays are simplified. Players would enjoy a heightened sense of entertainment if they know that an award is won before the winner identity and bonus amount won are revealed. Also, in mystery bonus awards that are a function of wagers made, it would be useful to illustrate that larger wagers have a greater likelihood of winning. Furthermore, it would heighten player enjoyment to have an indication of how close the next mystery award is to being won.

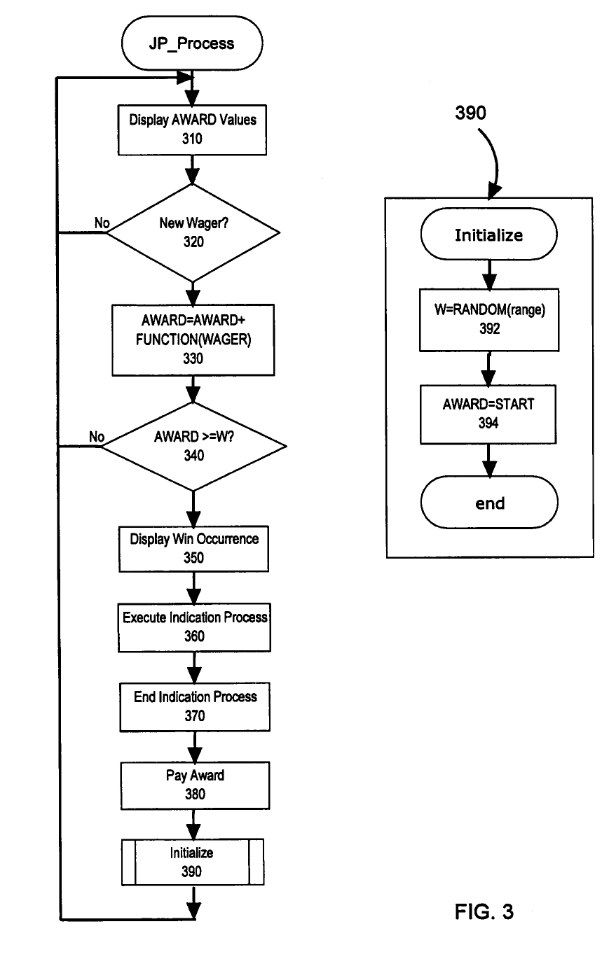

FIG. 3 is a flow chart representing a process for a four-level mystery jackpot award. As one of skill in the art will readily understand, each of the four mystery awards must be processed independently. FIG. 3 shows the logical flow of the award process so as to emphasize the unique attributes of the invention. Moreover, while the process shown describes a progressive mystery bonus award; the concepts of the invention apply equally to fixed value mystery awards.

Each of the four AWARD values are displayed 310 and then a new wager is awaited 320. When a wager occurs, the amount of each of the four jackpot award amounts are increased as a function of wager amount 330, after which each AWARD amount is tested against the value W already chosen for that AWARD level 340. If no AWARD amount has grown to at least equal its associated value of W, the process returns to step 310 and displays updated AWARD values.

After one of the AWARD values has grown sufficiently, players are made aware of the win occurrence 350. Next an indication process 360 is executed in which at least two of the four award values are indicated to players in a sequence. In a preferred embodiment of the invention, less than all of the award values are indicated at any one time. When the indication process ends 370, the award value that was won remains indicated, letting players know the amount won. The indicated award is then paid to the winning player 380, after which the award won is re-initialized 390 and the process repeated.

### Multi-Segmented Bonus Wheels

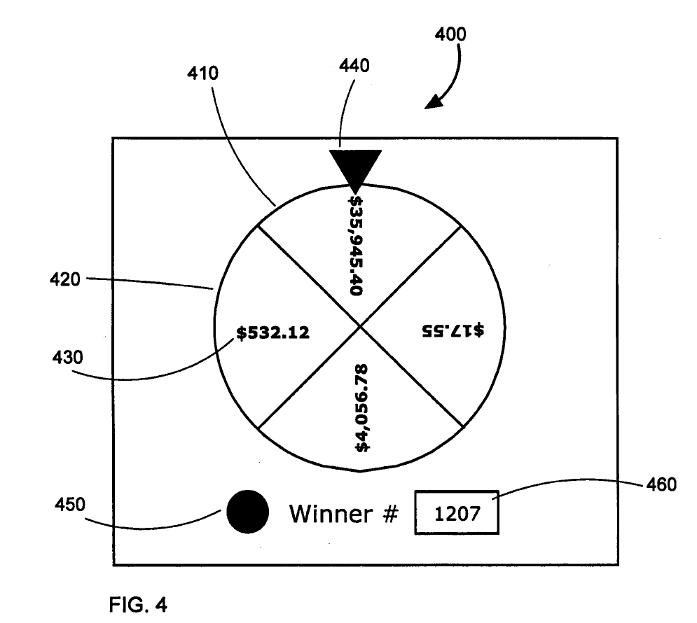

FIG. 4 represents a display which is useful for implementing the steps just described. A video display 400 displays a wheel 410. Each wheel segment 420 holds one of the four progressive bonus award values 430. During normal play, the wheel is stationary. After a win occurs at 350 of FIG. 3, win indicator 450 illuminates to inform players of the win occurrence. Next, wheel 410 begins to spin. Each award amount is indicated in turn as it rotates into alignment beneath pointer 440. The wheel then slows and finally stops, indicating the award won by stopping with that amount directly beneath pointer 440. In a preferred embodiment, corresponding sound effects accompany the win occurrence, wheel spin and celebration sequence after the wheel stops.

In a preferred embodiment, the winner identity is not disclosed until a time period after the amount won is made known. Referring again to FIG. 4, winner identifier 460 delays disclosure of the winner identity until several seconds after wheel 420 comes to rest and the amount won is known.

In an alternative embodiment, the winner is identified before the winning amount is made known. In yet another embodiment, the winner identity and bonus amount won are identified simultaneously.

### Win Proximity Indicator

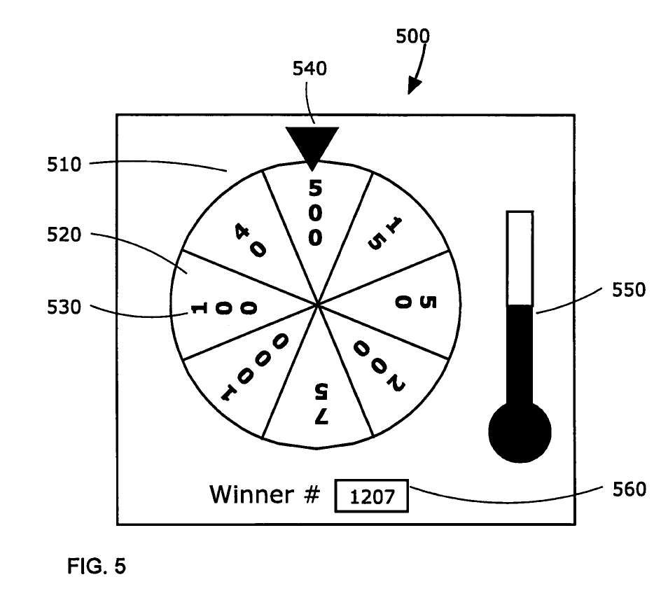

FIG. 5 is a video display of a wheel 510 which is divided into 8 segments 520, each containing a fixed award amount 530. Win proximity indicator 550—which in this embodiment is shaped like a thermometer—informs players of the proximity of the next mystery bonus award, as well as announcing each winning event. Upon initiation, the thermometer is set very low, indicating a winning event is not imminent. As wagers are made, the thermometer rises, indicating a winning event is growing closer. When a winning event occurs on any of the eight mystery bonus awards, the thermometer rises fully to the top and begins to flash, alerting players that a win occurred. After a period of time wheel 510 spins and stops, positioning the winning value beneath pointer 540. Winner identifier 560 identifies the winner and award payment is completed.

The purpose of win proximity indicator 550 is to show, in a non-numeric way, that a mystery win is growing closer with each wager. In one embodiment, the thermometer is lit in proportion to how much progress has been made toward the next winning event. Suppose a winning number W is selected from a range of 1 to 1,000 and a counter C, is increased by one count for each unit of wager made. That is, the counter is increased by 3 for each 3 credit wager made, 2 for each 2 credit wager made, etc. Now presume that, upon initialization C=0 and W=400, causing win proximity indicator 550 to indicate its lowest value because the win is far from occurring.

As wagers are made, C grows and win proximity indicator 550 rises in proportion to the percentage of progress C has made from its starting point to reaching the value of W. For example, after 100 credits are wagered, C=100 and is 25% of the way to a win. At this point the win proximity indicator has risen about 25% of the way to the top. Win proximity indicator height is recalculated after each wager, thereby providing players with a real sense of how quickly the next mystery bonus award will next occur.

FIG. 5 indicates 8 different fixed-value mystery awards. In a preferred embodiment, win proximity indicator 550 represents progress toward the nearest winning occurrence. When that award is accomplished, the win proximity indicator is reset to indicate the next nearest win occurrence. Therefore win proximity indicator 550 will rarely indicate its lowest value because when one win occurs, another win has also grown towards its winning value. This technique gives powerful incentive for players to continue to play and chase the next available mystery bonus award.

In another embodiment win proximity indicator 550 indicates progress toward the maximum theoretical value of W. In the above example, the largest value W could be is 1,000. When C=100 win proximity indicator 550 displays as 10% toward the top since 100/1000=10%.

Those of skill in the art will recognize these as just two algorithms for using a win indicator to represent progress toward a mystery win and that many other algorithms are possible.

Audio signals may be used to augment or replace the function of the win proximity indicator, the winner identifier, or both. For example, winner identity is announced using a live or recorded voice, and win proximity indicator functions are performed as a changing pitch, timbre, volume or content of sound. One of skill in the art recognizes there are many other mechanisms by which to electronically, mechanically or electromechanically indicate the functions of the win amount, win proximity, win occurrence indicator and winner identity. All such methods are useful with the invention.

### Mechanical Bonus Displays & Alternative Win Proximity Indicator

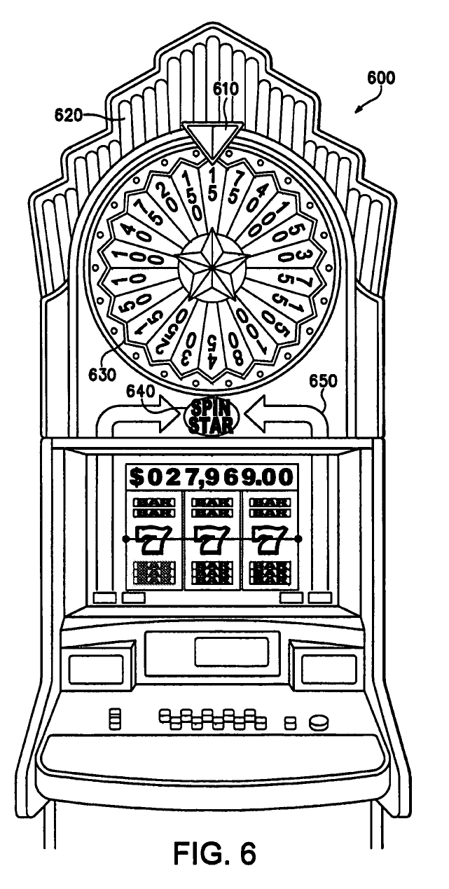

FIG. 6 depicts a mechanical wheel embodiment of the invention implemented using a Bally CineVision gaming machine 600. Mechanical wheel 630 includes 22 segments, each containing a fixed mystery bonus award. Pointer 610 indicates the winning amount. Win proximity indicator 620 is a crown of crystals. Each crystal of the crown is equipped with a multi-color illumination source. When the game is initialized, the crown is colored an icy-blue, indicating an award is not imminent. The crown illumination turns from icy-blue to reddish to bright red as a mystery win grows closer and closer. When a win is struck, the crown turns red and flashes, indicating a win occurred. Those of skill in the art will recognize that other color and brightness patterns may be utilized to represent the nearness of a mystery win and that win proximity indicator 620, though different in visual appearance, performs the same function as thermometer shaped win proximity indicator 550 of FIG. 5 and is adaptable to the same functional embodiments.

Once a win occurs, wheel activation button 640 illuminates. When the player presses the button, wheel 630 spins, slows and ultimately stops in such a position that the won mystery bonus amount is positioned directly beneath pointer 610.

Although the wheel depicted in FIG. 6 contains only fixed value mystery awards, one of skill in the art readily understands that some, or all, of the fixed award values could be replaced with progressive award amounts. One skilled in the art will further understand that wheel activation button 640 could be eliminated and wheel 630 automatically spun, either immediately upon a win being struck or after a time delay. In an alternative embodiment, wheel 630 could spin after a win occurs and wheel activation button 640 is pressed or a predefined period of time has passed, whichever occurs first.

While the examples of the invention that I presented above describe a wheel rotating beneath a fixed pointer, one of skill in the art will readily understand that other methods of indicating a winning amount on a wheel are possible. For example, the wheel could remain stationary while the pointer revolves around it, much like a roulette ball rotates around a roulette table. The amount indicated on the wheel segment that is aligned with the pointer when it comes to rest is the amount won.

Alternately, the wheel and the pointer could simultaneously rotate, either in the same direction or opposite directions. The amount indicated on the wheel segment that is aligned with the pointer when both wheel and pointer come to rest is the amount won.

When a fixed pointer is used, it need not be at the top of the wheel but could be located anywhere around the circumference of the wheel. In another embodiment, a player is allowed to choose one pointer from a plurality of pointers. After pointer selection is made, the wheel is spun. The award amount that is aligned with the chosen pointer when the wheel stops is the amount won.

One of ordinary skill will readily see that the invention is useful with any of the above mentioned methods of displaying award amounts on a wheel. For example multiple pointers can be active simultaneously and the award indicated when the wheel and pointers come to rest are the amounts won. The player may win the highest value indicated by the plurality of pointers, or the player is paid the sum of all values indicated by all active pointers.

As an alternative to mechanical wheels or video depictions of wheels, the image of a segmented wheel can be backlit with one illuminator for each wheel segment. Such implementations are known in the art as light wheels. The illuminators are lit, one at a time, in sequence, to simulate rotation. Whichever segment is lit when the sequence comes to a halt is the amount won. These are but two of many other methods of illumination which can be utilized with the invention.

### Wager Size Indicator

Turning again to FIG. 6, wager size indicator 650 is constructed of a number of illuminators arranged in the shape of an arrow on the right and left sides of wheel activation button 640. Each time a wager is made, these illuminators flash from the base of the arrow towards button 640. The brightness and duration of the flash is proportional to wager size. Gaming machine 600 is a three credit game, that is, players may wager one, two or three credits per game played. If three credits are wagered, illuminators 650 flash brighter and remain lit longer than if two credits are wagered. And a two credit wager causes an illumination flash that is brighter and longer-lasting that a single credit wager.

One of skill in the art understands that the shape in which the illuminators are arranged, the quantity of illuminators used and the color and brightness with which they indicate wager size and nearness to a mystery win can be varied according to need, so long as it is demonstrated to players that larger wagers are more likely to win a mystery bonus award than smaller wagers. Alternatively, in FIG. 6, audio cues (not shown) may be used to supplement or replace visual indicators.

### Alternative Bonus Displays

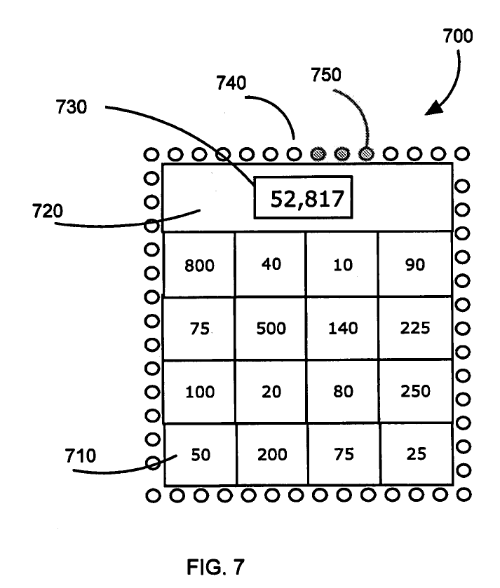

FIG. 7 depicts an alternate display configuration embodiment of the invention. Overhead display 700 contains sixteen separate fixed mystery award indicators 710 and one mystery progressive award indicator 720 which surround progressive award display 730. Each of the sixteen fixed mystery award indicators 710 and the one mystery progressive indicator 720 is backlit by an illuminator and each is associated with its own randomly selected winning number W and counter which is incremented as a function of credits wagered. Until one of the seventeen mystery awards is won, all of the illuminators behind the seventeen award indicators are turned off.

The set of award displays is surrounded by a win proximity indicator implemented as individual illuminators 740. At initiation, all illuminators 740 are off. As play ensues and a win on any of the seventeen awards grows closer, illuminators 740 are lit one at a time, starting at the first illuminator located clockwise of the 12 o'clock position. In the embodiment depicted in FIG. 7, the first three illuminators 750 are lit. Because each counter and each associated lucky number W is known within the system, it is straightforward to calculate how many wagers remain before a win occurs.

As any win grows closer, a proportionate number of illuminators 740 are lit in clockwise sequence. The illumination sequence is conducted so that the very last illuminator 740, which is at the 12 O'clock position, is lit when a win occurs. At this time all illuminators 740 are lit, completely encircling the array of seventeen award displays. When this happens, the illuminators behind each award display 710 and 720 are lit, one at a time. After one of the award displays is lit for a brief time, it extinguishes, and another of the award illuminators 710 or 720 is lit. Each illuminator is lit in a pattern so that all illuminators are lit once in each sequence which then repeats. Over the period of a few seconds, the sequencing speed slows until only the award display that was won remains illuminated and that amount is awarded to the winning player.

### Means of Implementation

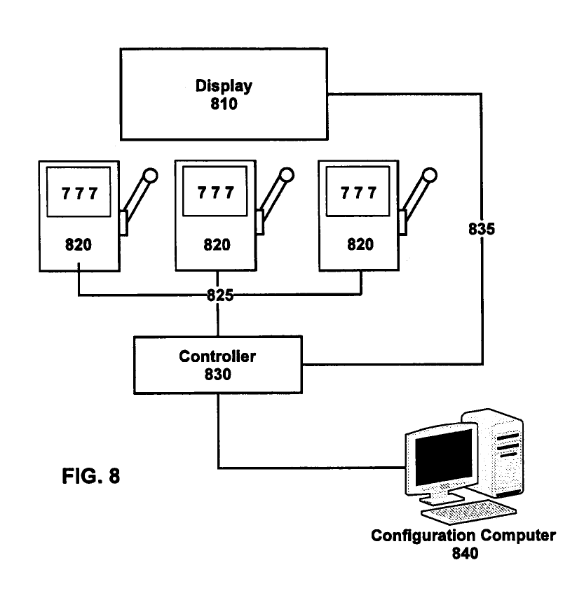

Referring now to FIGS. 8-10, I now describe various means of configuring the invention. FIG. 8 depicts a schematic representation of a linked implementation of the invention. Controller 830 is configured by means of configuration computer 840 with the number of mystery awards, the size of each, the rate of increment for each wager, and the range from which winning numbers are to be randomly selected, amongst other parameters. One of skill in the art will recognize that configuration techniques for mystery award controllers are well known and all such configuration means may be used with this invention.

Controller 830 may also be configured to implement an eligibility engine which communicates with each of the gaming machines 820 to track play. Minimum criteria for eligibility are configured within the configuration computer 840. Eligibility in this case refers to minimum thresholds of play or status on the gaming machine or machines 820 to allow a player or players to view or otherwise receive cues from the win proximity indicator such as shown in FIGS. 5-7 as win proximity indicators 550, 620, and 750. Accordingly, triggering of the win proximity indicator on the display occurs only when play bears a defined relationship to a determined play value.

Examples of eligibility tracked by the eligibility engine are, for example, attaining a certain minimum rate of play (e.g. credits played per minute), a minimum elapsed time between wagers, whether a max (e.g. 3^{rd}) credit has been played for that or the previous x number of games, whether a minimum number of credits (e.g. >0) remain on the machine, the attainment of a certain player (e.g. gold) status, the time of day, or a combination of two or more of the above.

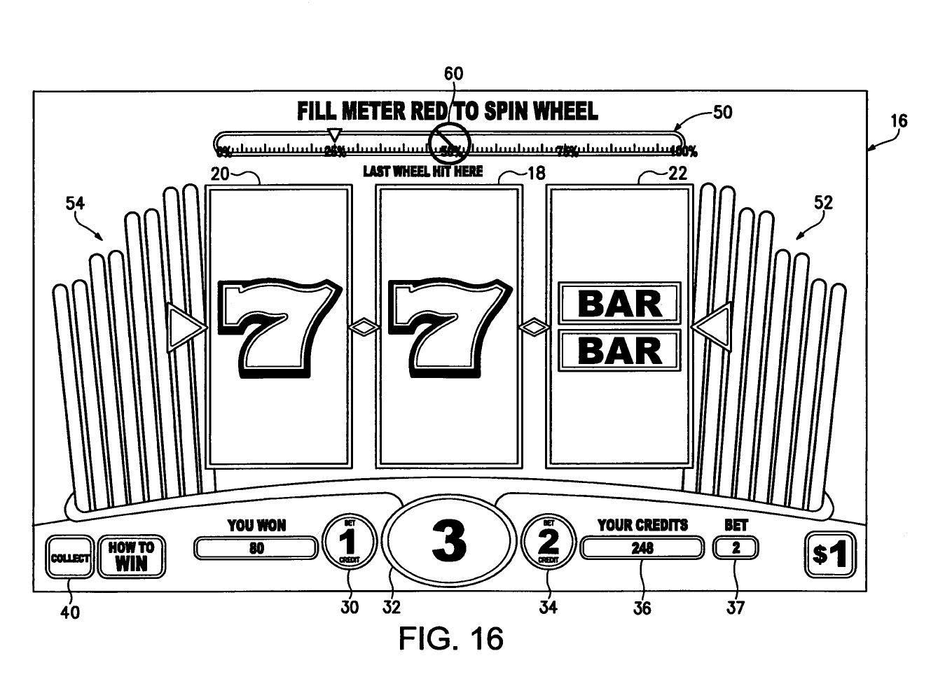

If eligibility is determined by the eligibility engine, then the proximity indicator is operated as by displaying the level of the thermometer 550 in FIG. 5, the color of the lights in FIG. 6, or the lighting of the peripheral lights 750 in FIG. 7. Other indicators, whether visual cues, audible cues, smell, or touch may also be possible. If the eligibility indicator determines that eligibility is not met, then the proximity indicator is deactivated such as indicated further below with reference to FIG. 16.

In FIG. 8, three gaming machines 820 are shown, though any number may be used, including a single machine. Each is connected to controller 830 through connection 825. In a preferred embodiment, this connection is a two-way serial protocol capable of allowing the controller 830 to receive information about game play, including wagers made from each gaming machine and also to send payout messages to each gaming machine for payment when a mystery award is won on that gaming machine. Examples of such two-way protocols include the well-known existing industry standard SAS protocol and the industry standard protocol in development by the Gaming Standards Association.

In yet another embodiment, connection 825 is a one-way transfer of information from each gaming machine 820 to controller 830. Such connections are less preferable because automated award payments are not supported. Eligibility may therefore be tracked within the gaming machines 820 themselves.

Gaming machine designs sometimes utilize Ethernet, USB or other such high-speed network connections which offer the advantage of high-bandwidth and are useful for carrying information for many purposes from gaming machines to many kinds of controllers and database systems. These connections are being adapted for other casino functions such as player tracking, casino accounting and security. One of skill in the art will appreciate that such high-bandwidth connections are useful with the invention whether they are used exclusively for the purpose of transferring mystery award information or if the connection serves a variety of other purposes as well.

Connection 825 may also be implemented via wireless protocol such as Bluetooth, Zigbee, wireless Ethernet or other protocol whether based on radio frequency (RF), infrared or other technologies.

Connection 835 transfers information between controller 830 and display 810. This connection may be of a wide range of electrical protocols such as RS-232 or it may utilize more recent protocols that specify electrical, connector, cabling and information communication structure such as Ethernet or USB. One of skill in the art will appreciate that a wide variety of standard and proprietary connector, cable, electrical and information structure protocols may be used with this invention, including wireless protocols.

The transfer protocol for connection 835 may be one-way from controller 830 to display 810, or more preferably, two-way, with information flowing from controller 830 to display 810 and from display 810 to controller 830.

Although a single display is shown, multiple displays may be used and the displays may be mounted over or near a bank of gaming machines, on individual gaming machines or as remote displays away from the gaming machines to which they are associated.

Once controller 830 is configured and connected, wagering information from each gaming machine 820 is transmitted to the controller via connection 825 where it is used to increment the counter(s) which are then compared against the list of Winning values W. If the configuration includes progressive mystery awards, the updated award values are transmitted to the display 810 via connection 835 for presentation to players. Information for winner identification, win proximity, wager size and win occurrence are also sent from controller 830 to display 810.

When connection 835 allows two-way communication, display 810 returns information back to controller 830, including acknowledgement that each message sent from the controller was received, diagnostic information that the display is functioning properly and other such housekeeping and award information.

Display 810 may be a video display and preferably includes a processor for rendering the required images and updating the image with information received from controller 830. Any type of video display is useful including LCD, Plasma, rear-projection DLP, CRT, LED, VFD or any other technology capable of rendering the desired image for presenting information to players about award values, win occurrences, wager sizes, win proximity, etc.

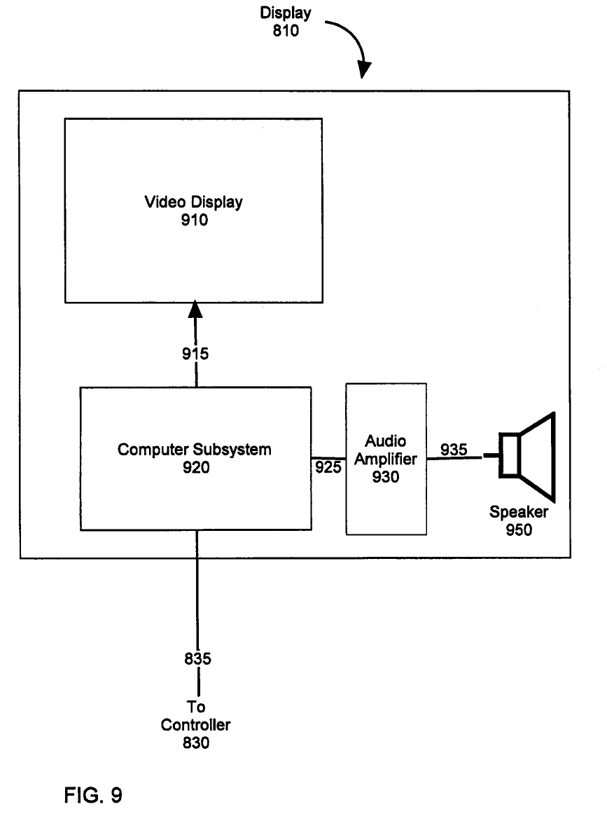

FIG. 9 illustrates video display 910 connected to computer subsystem 920 via connection 915. The video display 910 is preferably a flat panel display using LCD or plasma technology as such displays are economical, widely available, long-lived and require little physical space. Of course, any other video display technology may be used.

The computer subsystem 920 is preferably a personal computer running Microsoft Windows, Linux, or Apple's OS X, though other operating systems may be desirable in certain situations. The computer subsystem may render the image using Macromedia's FLASH programming methodology or it may use alternative application software for rendering. As virtually all computers do, computer subsystem 820 includes a case, power supply, main processor such as an Intel Pentium, a graphics coprocessor, or separate processing card such as an ASUS EN7600GT video interface for driving the video display, standard memory such as DRAM, non-volatile memory such as a hard disk and/or CD_ROM, DVD player, flash memory, battery backed RAM or some combination therein. The operating system, applications programs and data are stored in non-volatile memory and loaded into processor memory, usually DRAM, as needed. All such computer components, and other associated components that may be optionally used, are well known to those of skill in the art and will not be further described here.

The connection 915 between computer subsystem 920 and video display 910 may be, but not limited to, VGA, DVI, HDMI, component video, or less-preferably S-video or composite video.

Another benefit of using a personal computer for video rendering is that most such computers include powerful capabilities for creating and storing audio waveforms. Connection 925 takes the output from computer subsystem 820 audio output to an audio amplifier 930. Connection 925 may be analog or digital audio signals such as optical TOSLINK or coaxial SPDIF, or other such cable for carrying monophonic, stereo, or surround sound information.

Audio amplifier 930 may be analog amplification sufficient to drive the chosen speaker or speakers 950. For example, the audio amplifier could be a two channel 50 watts RMS per channel amplifier as is readily available from many well-known sources. Alternately, the audio amplifier 930 could contain an audio processor for processing surround sound information from either the analog inputs or from digital inputs.

Speaker 950 may be a single speaker or a pair of speakers for stereo sound. Alternately, speaker 950 could be a set of speakers to implement surround sound in 5 or 7 channels, or other configuration. Each speaker channel may include a simple single cone speaker or an array of speakers for desired sound dispersion and/or improved frequency response. Subwoofers could be included for enhanced low frequency response.

Computer subsystem 920 connects to controller 830 via connection 835. Personal computers today typically include RS232, Ethernet and USB ports with a range of optional wired or wireless ports on specially configured computers or by adding an interface card to the standard personal computer.

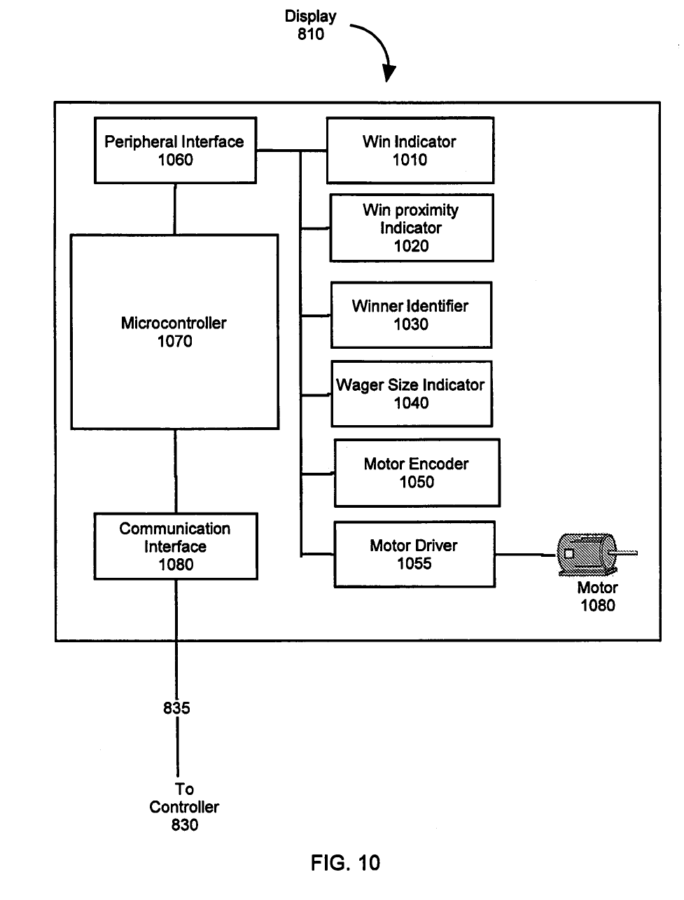

FIG. 10 depicts a schematic representation of circuitry to enable a mechanical wheel display for use with controller 830 of FIG. 8. The video display of FIG. 9 is interchangeable in function with the mechanical wheel display of FIG. 10. One of skill in the art will recognize that these types of displays may be used together or separately and that many other types of displays are useful with the invention.

In FIG. 10, microcontroller 1070 transmits and receives commands and information to and from controller 830 via communication interface 835. The microcomputer is connected to win indicator 1010, win proximity indicator 1020, winner identifier 1030, winner size indicator 1040, motor encoder 1050 and motor driver 1055 through peripheral interface 1060.

Win indicator 1010, win proximity indicator 1020, and wager size indicator 1030 are typically arrangements of illuminators such as LEDs or light bulbs. These illuminators may be changed in brightness, color, pattern or a combination thereof as required to indicate the particular function and create excitement in a given environment. For example, the win proximity indicator could be shaped as thermometer 550 of FIG. 5 a crown of lights 620 surrounding wheel 630 as depicted in FIG. 6 or individual illuminators arranged as 740 in FIG. 7. Proximity indicator 1020 may be disabled responsive to instructions from controller 830 operating under the eligibility engine.

Motor 1080 has the wheel indicator connected to its shaft and may be a DC motor, an AC motor, a stepper motor or other type of motor as fits the size and weight of the wheel and the desired control in positioning and stopping the wheel. Motor driver 1055 is used to convert signals received from microcontroller 1070, via peripheral interface 1060 into a format and capacity for driving the motor. Motor encoder 1050 provides feedback on the motor position, allowing microcontroller 1070 to sense exactly when to stop motor 1080 so as to indicate the correct award on the wheel.

Motor controls and wheels are well-known to those of skill in the art. The same technology that is useful in controlling the wheels used in International Game Technology's “Wheel of Fortune®” and Bally Gaming's “Monte Carlo®” may be used in the invention.

The schematic depicted in FIG. 10 is readily adaptable to controlling a reel, which is simply a wheel turned on its side and with award values disposed on its circumference, much like a slot machine reel. A payline on the front of the reel housing indicates the winning mystery bonus amount, much like a payline on a slot machine indicates the paying symbols.

Controller 830 may also be implemented using a personal computer or other suitable electronic control mechanism, a wide variety of which are well-known to those of skill in the art.

### Gaming Device with Proximity Indicator

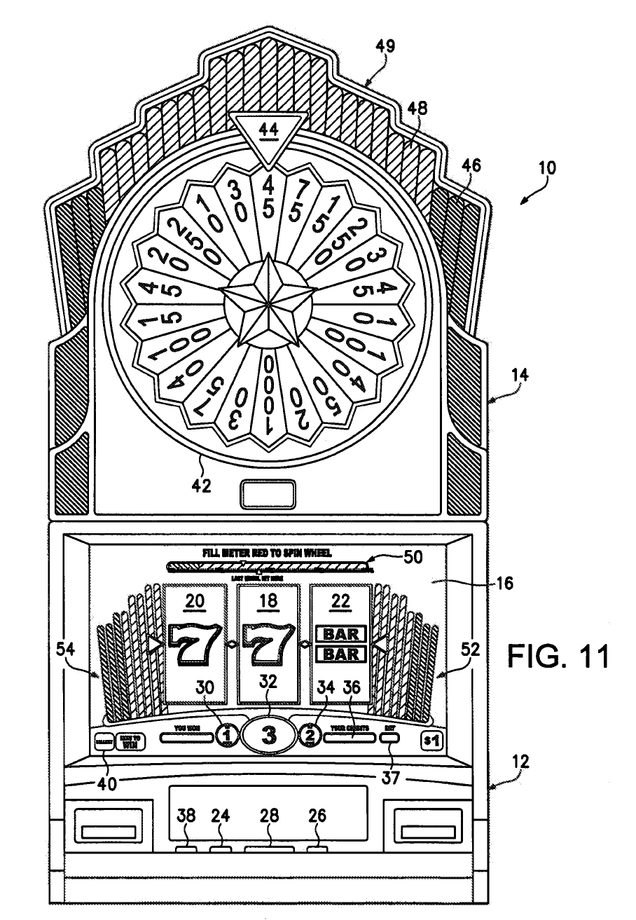

Turning now to FIG. 11, indicated generally at 10 is a gaming device constructed in accordance with the present invention. The gaming device includes a base game 12 and a secondary game 14. As with the embodiment of FIG. 6, gaming device 10 incorporates a Bally CineVision gaming machine. In gaming device 10, the Bally game comprises the base game.

The Bally game includes a display 16 that comprises an LCD screen. Display 16 displays information about the outcome of the video slot game played by base game 12 in the form of three video reel symbols 18, 20, 22. It also displays, on either side and above the reel symbols, information related to the secondary game, which will shortly be described more fully.

In the present embodiment, the base game accepts wagers of one, two, or three credits. These are placed by pressing a corresponding one of buttons 24, 26, 28, respectively. Alternatively, or in addition, touch screen symbols 30, 32, 34, respectively, may be used to place a bet. Display 16 further includes a Your Credits display 36 for showing total credits on the machine, including credits applied by a player as well as credits won as a result of play. A Bet display 37 shows the amount bet on the current game. A cash-out button 38 permits a player to receive all of his or her credits on the machine at the conclusion of play. A corresponding Collect image 40 can be provided to facilitate the same function, either alternatively or in addition to button 38.

Secondary game 14 includes a rotatable mechanical wheel 42, although it should be appreciated that other types of indicators, including lighted simulations of wheels and other indications, could be equally well used. When the secondary game is enabled and played, wheel 42 rotates about an axis in the center of the wheel. A pointer 44 points to one of the awards in the segments of wheel 42 when it comes to a stop, thus indicating the amount awarded in the secondary game. As with the other embodiments, the opportunity to play the secondary game is a mystery award that is not tied to the outcome of the base game.

Gaming device 10 indicates in several ways how close the player is to being eligible to play the secondary game, i.e., how close the mystery bonus is. First, illuminated polymer rods, like rods 46, 48, span the top of the gaming device above the wheel and form a semicircular lighting bank 49. In this view, rod 46 is colored red as are all other rods that are similarly designated with upper-left to lower-right cross hatching. Rod 48 is colored blue as are all other rods that are similarly designated with lower-left to upper-right cross hatching. As will be described in more detail, as the likelihood of playing the secondary game, i.e., the mystery bonus, becomes higher, the color of the rods progressively changes so that more become red as fewer remain blue.

The second way in which the player is informed about the proximity to the mystery bonus is a meter 50, which comprises an image on display 16 above the image of reel symbols 18, 20, 22. As will also be described in more detail, a left portion of the meter is red and a right is blue with the left portion progressively moving to the right thus making the meter more red and less blue as the mystery approaches.

The third way that the player is informed about progress toward the mystery bonus is by images of rods 52, 54, which flank either side of the reel images and which mirror the progression in color of the polymer rods on the top of gaming device 10. Rod images 52, 54 are also hatched in the same fashion as rods 46, 48 to indicate color.

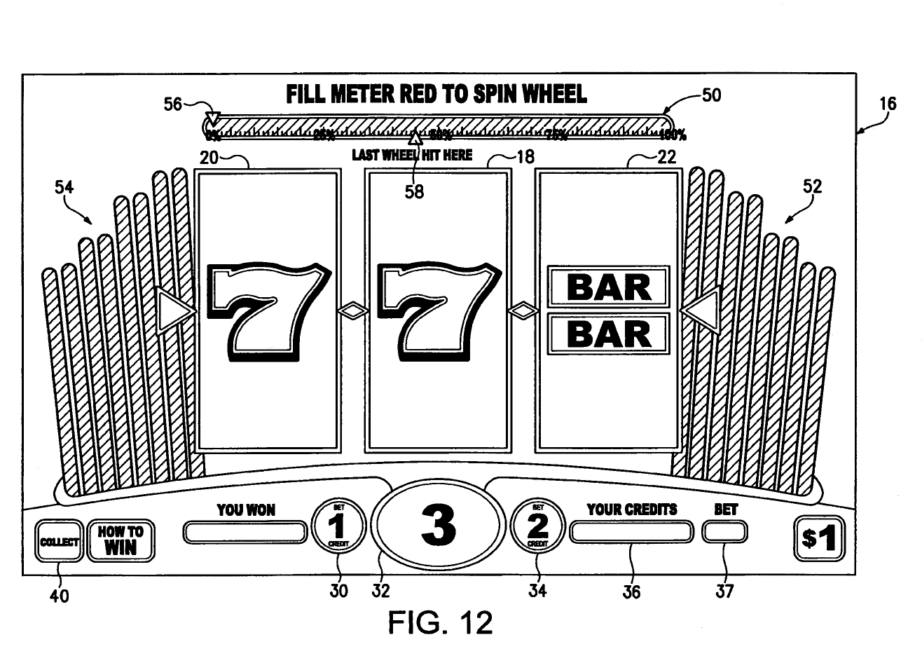

Consideration will now be given to play of the game from a player's perspective before description of the hardware and software to implement the game. Turning now to FIG. 12, display 16 is shown after a play of the bonus game. As a result, the meter 50 is illustrated as being all blue, indicating that the player may be far from obtaining a mystery bonus (e.g. “cool/blue” as opposed to “hot/red”). It should be appreciated, however, that a mystery round is typically started at a low end of a range defined by low and high numbers so that even after the secondary game has just been played, the red portion of the meter will indicate a starting point at zero, although the initial starting point could be above zero as well.

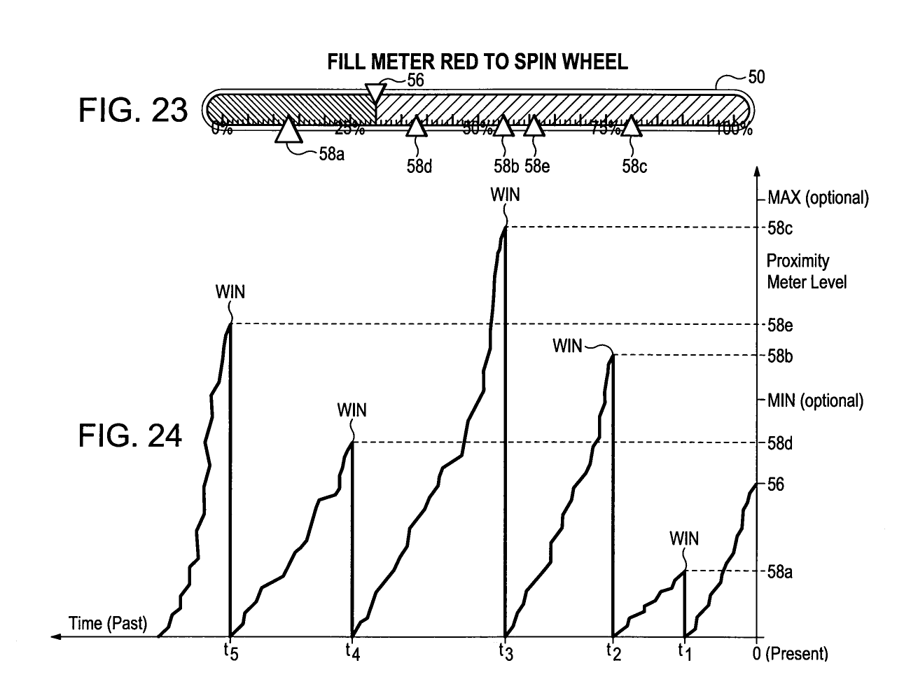

Meter 50 further includes pointer images 56, 58. Pointer 56 is aligned with the dividing line between the red and blue portions of the meter, thus indicating progress toward another secondary game. Pointer 58 points to the location on the meter when the last mystery was triggered. Additional pointers (FIG. 23), similar to pointer 58, could be added to indicate the location on the meter when the mystery was triggered for the last two, three, or more secondary games.

Fill meter 50 is shown in the figures with demarcations illustrating a percentage of fill from zero percent to one hundred percent. Bonus trigger amounts may be randomly selected between a high and a low value. As one example, the low trigger amount may be set at 20 and the high trigger amount may be set at 120. At the start of each bonus session—e.g. after a player wins the mystery bonus award—the trigger amount is reset and a new trigger amount is determined by a random number generator selecting between these two values. Pointer 58 in FIG. 12 is shown at the 45% fill point along meter 50. In the example given, there are 100 possible trigger values between low value 20 and high value 120. With each advance in the count, therefore, pointer 56 advances to the right by one tick mark, which is equivalent to one percentage point on the fill meter 50. One can infer from the location of the previous win marker, pointer 58, that the trigger value of the previous bonus game was set at 65 (min. value 20+100×45%) by the random number generator. The bonus award in the previous game was thus triggered when the count reached 65.

Fill meter 50 comprises an elongate portion encompassing a range of trigger thresholds of the bonus award. The first win proximity indicator 56 is a moving pointer displayed along the elongate portion. The previous win indicators are indicia 58 shown in spatial relationship to the first proximity win indicator 56. Even though the fill indicator of meter 50 is not advanced completely to the right, a player might still be encouraged to play if their proximity win indicator 56 is spatially close to that of the previous win indicia 58, statically located along the elongate portion of the fill meter 50.

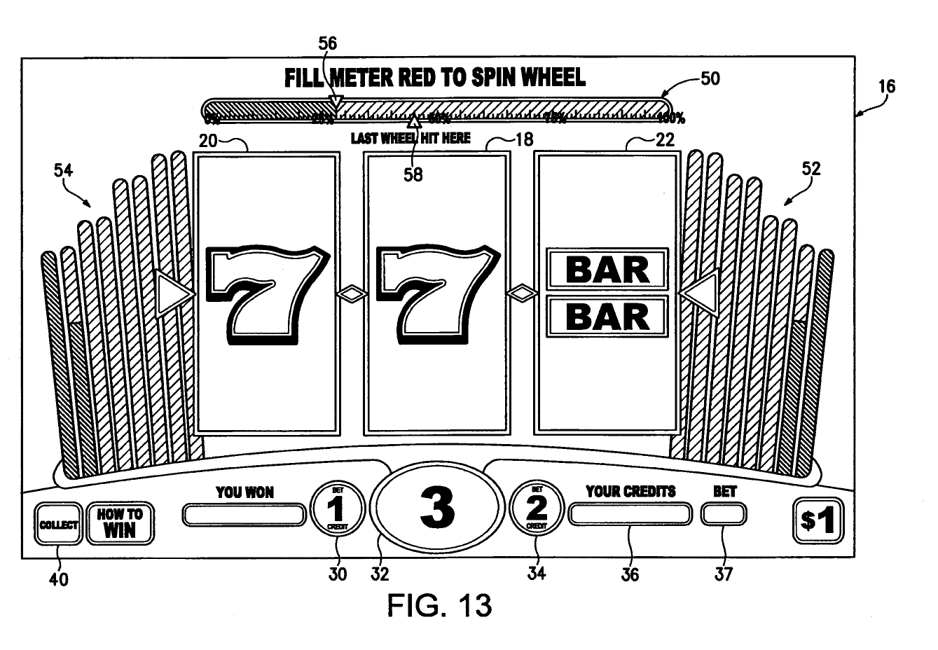

Continuing to FIG. 13, multiple plays on base game 11 have occurred so that pointer 56, as well as the red and blue images, indicate further progression toward the mystery bonus, i.e., play of the secondary game. As will be explained more fully in connection with a description of how the game is implemented, the progression of pointer 56 as play continues may provide an indication of how close the machine is to providing the mystery award or it may indicate how close the machine is to the upper end of a range that contains a randomly selected trigger of the mystery award, preferably the latter.

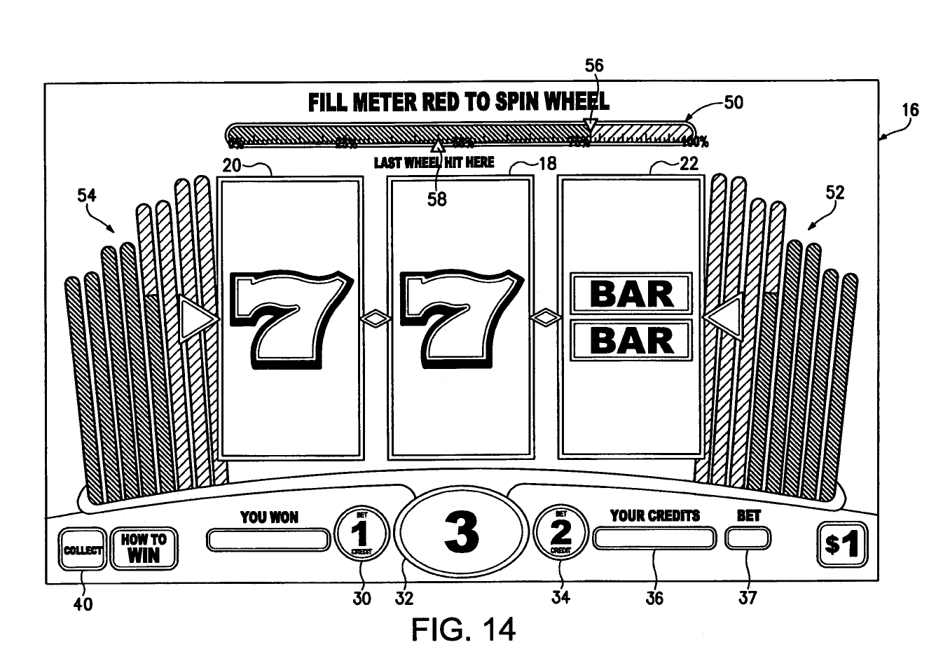

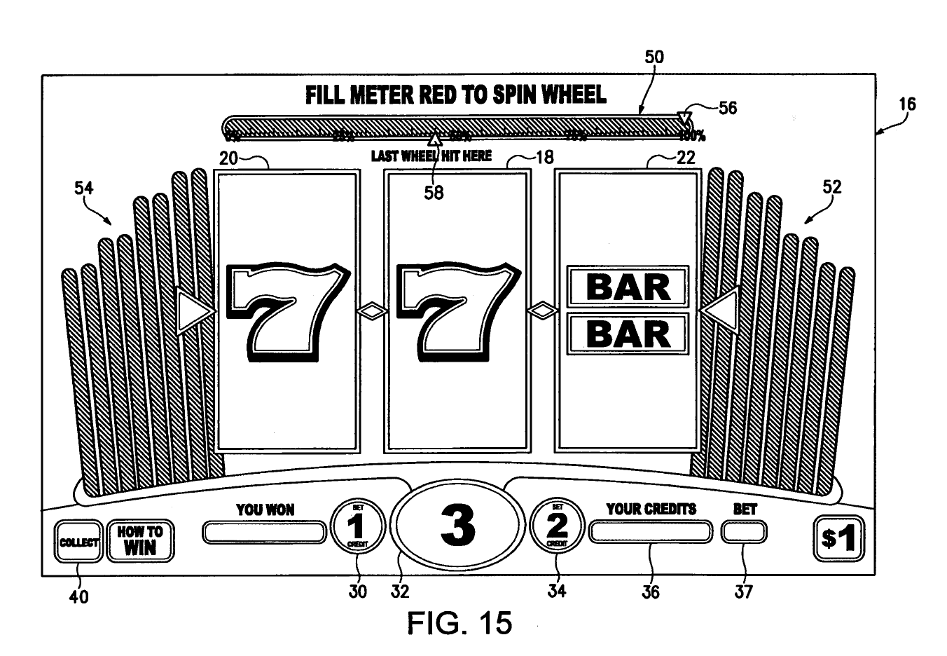

In FIG. 14, the pointer 56 has further progressed, and in this illustration, the machine has triggered play of the secondary game at the location of pointer 56 in FIG. 14. When this happens, pointer 56 and the corresponding dividing line between the red and blue images move rapidly all the way to the right, thus filling the meter with all red, as shown in FIG. 15. The player is then instructed, via display 16, to hit button 28 to play the secondary game. This initiates rotation of wheel 42, which spins and stops on a number indicating the amount of credit that then goes to the Your Credits display 36. The game is reset, as will be described, and progress begins toward the opportunity to play another secondary game.

In still another approach to displaying win proximity, the rightmost position of the meter is not tied to either the top value in the range from which the random trigger is selected or to the value of the random trigger. Rather, the rightmost meter value starts at the top value in the range from which the trigger is selected and changes toward the value of the random trigger as the count progresses. This results in meter movement proportional to more than one count at a time as the rightmost value of the meter decreases toward the random trigger value. Of course, the counter continues to count one count at time, and all of the counts between the lower end of the range and the random trigger must occur before the secondary game is triggered.

FIGS. 12-15 show an implementation of the invention where two trigger thresholds are set—the past trigger threshold identified by pointer 58, and the current trigger threshold toward which pointer 56 is advancing. In this implementation, the method for operating the gaming device 10 includes selecting at least two trigger thresholds, including a first past trigger threshold and a current trigger threshold. At least one count is generated in relation to the occurrence of wagers. The count is compared to the current trigger threshold, and the proximity of the count to the current threshold is indicated together with the first past trigger threshold. A bonus is awarded when the count substantially meets the current trigger threshold.

Responsive to awarding the bonus award, the current trigger threshold, e.g. the location at which pointer 56 triggered the bonus award as shown in FIG. 14, is converted to a new first past trigger threshold and displayed in place of pointer 58. A new threshold trigger would be selected and a new count commenced based on an occurrence of wagers after the previous bonus event. The new pointer 56 is then displayed along meter 50 to indicate the proximity of the new count to the new current trigger threshold and to the new first past trigger threshold.

FIG. 23 illustrates an embodiment when multiple indicators of past trigger thresholds are displayed simultaneously along meter 50. That is, instead of only showing the most recent past proximity resulting in a win (e.g. pointer 58), the system displays multiple past proximities. Accordingly, and responsive to awarding the mystery bonus award, the first past trigger threshold is converted to a new second past trigger threshold. That is, past trigger thresholds are maintained in the meter 50 display up to a certain limit. One such limit is a maximum number of such prior wins being displayed at one time, e.g. five such prior wins as shown in FIG. 23. Another such limit is time elapsed since the past wins. For example, the system can be set to only display past wins occurring in the past hour. The number of past wins displayed can also be linked to player status and/or eligibility such that high rollers may be allowed to see more past date that less frequent or lower value players.

Pointer 56 is thus akin to a dynamic indicator or other indicia moveable along a range of possible trigger amounts. Pointer 58 is akin to a static indicator displayed along that same range of possible trigger amounts.

FIG. 23 illustrates the embodiment whereby multiple past win indicators are displayed simultaneously along the same win proximity meter 50. The past win indicators run from most recent indicator 58a, to second-most recent indicator 58b, third-most recent indicator 58c, fourth-most recent indicator 58d, and fifth-most recent indicator 58e. In a preferred embodiment, the most recent indicator 58a is visually distinguished from the other indicators 58b-58e as by making indicator 58a a different color, larger size, flashing, animated, etc.

FIG. 24 is a chart that illustrates the advance of the count 56 over time. The count rises over time according to how often and/or in what way the machine or bank of machines are played. Flat spots in the count indicate periods of no play, or where play (e.g. below the Max bet) do not advance the count 56. Locations where the count 56 is more vertical indicate periods of more frenetic play, e.g. as the win proximity meter advances toward 100% (e.g. maximum trigger threshold). When the count reaches the first trigger threshold 58e, occurring at time t₅, the mystery bonus is paid out to the player. The count reset to zero and a new trigger threshold 58d is set. The count again advances over time due to play on the gaming machine or bank of machines and, at time t₄, the count reaches the trigger threshold. The mystery bonus is again paid, the count again reset, and a new trigger threshold 58c determined under operation of a random number generator. Play continues until the threshold 58c is attained (at time t₃), the mystery bonus awarded, and a new threshold 58b determined. Play continues similarly for trigger value 58b and for 58a, attained at times t₂ and t₁, respectively.

One notes that the example shown in FIG. 24 illustrates where there may be great differences between trigger thresholds, e.g. between threshold 58c and 58a. It may be possible to set a minimum threshold trigger (MIN) so that the amount of play prior to awarding the mystery bonus is increased. In the example shown in FIG. 24, the MIN is set higher than triggers 58d and 58a so that those values would not be valid to trigger a threshold. Accordingly, the time between awards is necessarily increased.

Gaming machines configured with this feature of the invention would include a display configured to provide a graphical indication of the change in likelihood of awarding the bonus award and provide a graphical indication of the relationship of the past trigger threshold to the change in likelihood of awarding the bonus award. The display can be more generally configured to provide an indicia of a previous win 58 of the bonus award together with the win proximity indicator 56. It is understood that the “likelihood of awarding the bonus award” is only perceptive to the player, since the gaming machine will have often predetermined the trigger threshold. However, the overall statistical likelihood of a player winning is reflected in the fill meter 50 since a player is more likely to win (or have won) if their count, represented by pointer 56, is closer to 100% of the maximum possible trigger value.

In a preferred embodiment, only a maximum credit bet (3 credits in the game depicted here), qualifies the player to play the secondary game. A bet of one or two credits will result in the player not being eligible to play the secondary game according to rules set forth in the eligibility engine operating at controller 830 (FIG. 8) or within the machine 10. When deactivation of the win proximity occurs due to non-qualification, all of the displays that indicate progress toward play of the secondary game may be shown in gray, as can be seen in FIG. 16. And the rods, like rods 46, 48 (FIG. 11), also become a gray or neutral light. A symbol (a circle with a slash) 60 also appears over meter 50 to indicate that there is no eligibility nor will the progress toward the game be displayed. Alternatively, one or more of these win proximity indicators may be shown even when the wager is less than the maximum possible wager. In still another implementation, only wagers that are less than a predetermined value are counted, e.g., only wagers of one credit or of one or two credits.

The term “graphical” as used herein means a pictorial representation. This could include changes in images on a display, changes in light intensity, changes in color, or a combination of the foregoing, whether or not combined with numeric, alphabetical or alphanumeric displays.

In an alternative embodiment, audio indications could be used in lieu of or in addition to graphical indications of win proximity. Substantially the same controls used that are used to create graphical indications of win proximity could be used to create audio indications. In other words, signals generated by the controls are applied to an audio system that provides an audio indication of the change in likelihood of awarding a bonus award.

Sometimes casinos are plagued by undesirable players, some of whom operate in teams, looking to play games only when a mystery award appears to be near. Because prior art systems, as described above, show the current value of an award and because the high end of the award is known, players may begin playing minimum credits only until the award is near. This reduces revenue from the games and potentially awards these undesirable players at the expense of patrons who generate more revenue for the casino. These undesirable players are discouraged by requiring maximum credits to be eligible for the mystery award and by preventing display of the mystery proximity when less than maximum credits are played. Other rules may be implemented within the eligibility engine to activate or deactivate one or more win proximity meters, e.g. time between wagers, credits remaining, player status (e.g. automatically for a newly incoming player for the first 15 minutes of their wagering, and thereafter only if they reach gold status), time and date (e.g. the proximity meter may be available only during special occasions), etc., and any combination of the above.

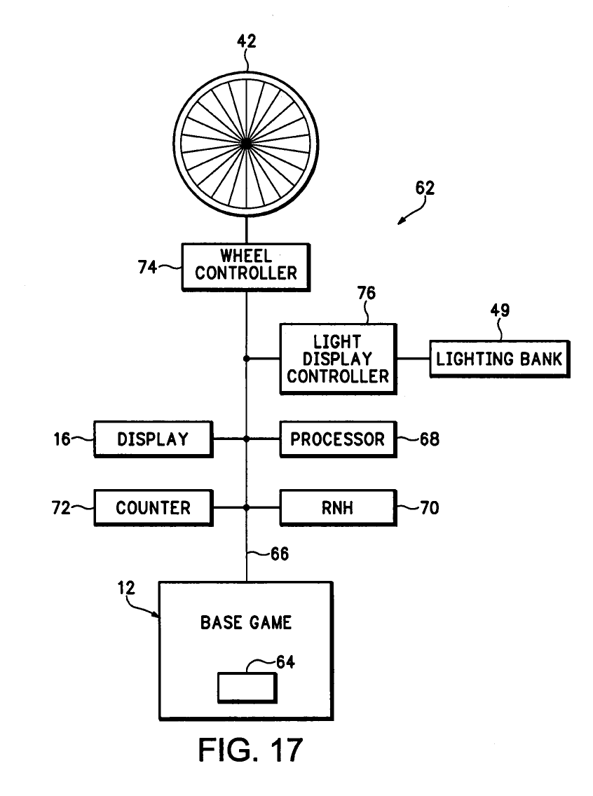

With reference to FIG. 17, consideration will now be given to the implementation of gaming device 10. Indicated generally at 62 is a highly schematic diagram of some of the components of gaming device 10. Components that have been previously identified retain the same numeral in FIG. 17. Base game 12 includes a pay table 64 that controls the odds of producing various combinations of reel symbols 18, 20, 22 (in FIG. 11), some of which provide associated base-game awards. Control of video slot machines that implement such pay tables is well known. Although display 16 is built into the base game, inputs into the base game permit images related to the secondary game, as described above, to appear on the display along with the base-game reel symbols.

A bus 66 communicates with base game 12 and display 16. Also in communication with the bus are a processor 68, a random number generator (RNG) 70, a counter 72, a wheel controller 74, and a light display controller 76. Processor 68 is programmed, as will be soon described, to selectively activate wheel controller 74, which in turn causes wheel 42 to spin and stop at a preselected number.

In the present embodiment, processor 68 is part of the base game. In addition to controlling the base game, additional programming, as will be explained, is implemented to control the secondary game. For example, processor 68 is programmed to trigger RNG 70, which in the present embodiment is implemented in software, upon completion of a secondary game to select a new trigger threshold for the next secondary game. Counter 72, also implemented in software in this embodiment, counts each base game played with maximum (in this case 3) credits, and when the trigger threshold is reached, processor 68 triggers the start of the next secondary game. Additional counters could be implemented to count toward their associated trigger thresholds to provide additional awards via additional bonus award mechanisms. This could be an implementation in which each of the segments in wheel 42 has its own associated counter, trigger threshold and award as described above in connection with a different embodiment. The bonus award mechanism in the present embodiment of the invention comprises the software and associated hardware that delivers the bonus to a player.

The processor also indicates which light displays, both on display 16 and on lighting bank 49, are presented depending upon the state of game play.

In another approach, the odds of playing the secondary game may be improved by changing the odds for a random number generator (RNG) to trigger the secondary game after each play of the base game. For example, an RNG could be programmed to have a 1/200 chance to trigger the secondary game after the first play of the base game and thereafter reduce the odds after each successive game in the following sequence: 1/199, 1/198, 1/197 . . . 1/1 until the secondary game is triggered. In a variation on this aspect, the odds might only reduce after each game to a certain level and then hold at that level for additional base games.

In another variation, the odds of winning decrease with each successive play. For example, on the first play odds of 1/10 are provided for winning the secondary bonus. On the second play, odds of 1/11, etc. Odds of winning the secondary bonus could continually increase or decrease, increase or decrease until a limit was reached or increase for a period of time and then decrease and then increase again. In addition, odds could change after one or more wagers and not change after another one or more wagers. Any such sequence of successively changing odds is useful with the invention. One of ordinary skill in the art could readily implement this variation.

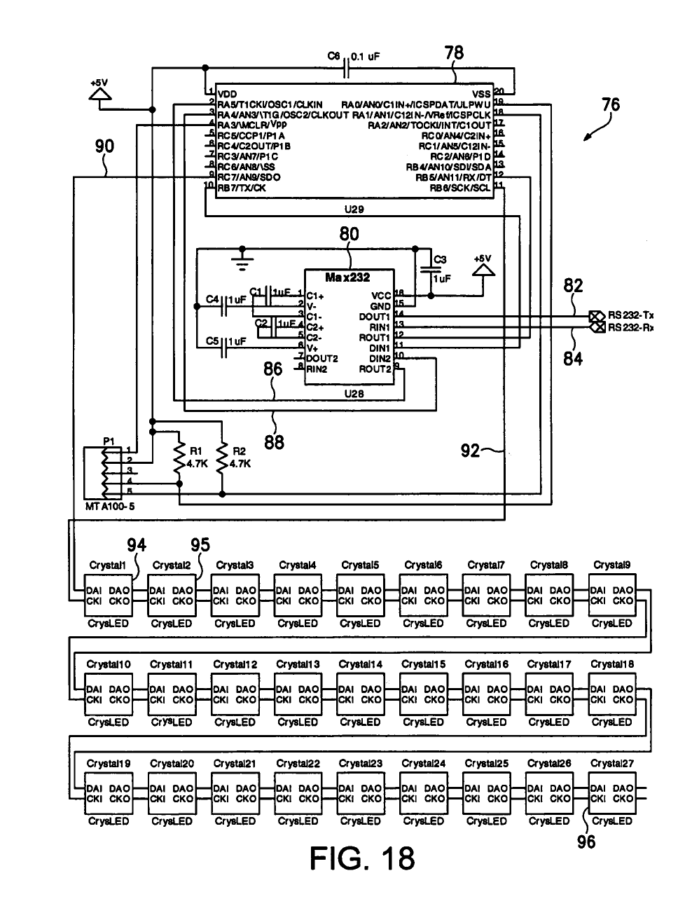

FIG. 18 comprises a schematic diagram of light display controller 76 in FIG. 17. Light display controller 76 includes a Programmable Intelligent Computer (PIC) microprocessor 78 and an RS232 interface 80. Interface 80 communicates with processor 68 via a transmit line 82 and a receive line 84. Interface 80 in turn communicates with PIC microprocessor 78 via lines 86, 88.

The PIC microprocessor includes a serial data out (SDO) line 90 and a clock (CLK) line 92 that are connected to a light module 94, which is the first in a chain of light modules, including the next light module 59 and the last light module 96. There are a total of 27 light modules, one for each of the rods, like rods 42, 42, in light bank 49. As will soon be seen, each light module controls the light in a particular one of the rods to create a variety of lighting effects.

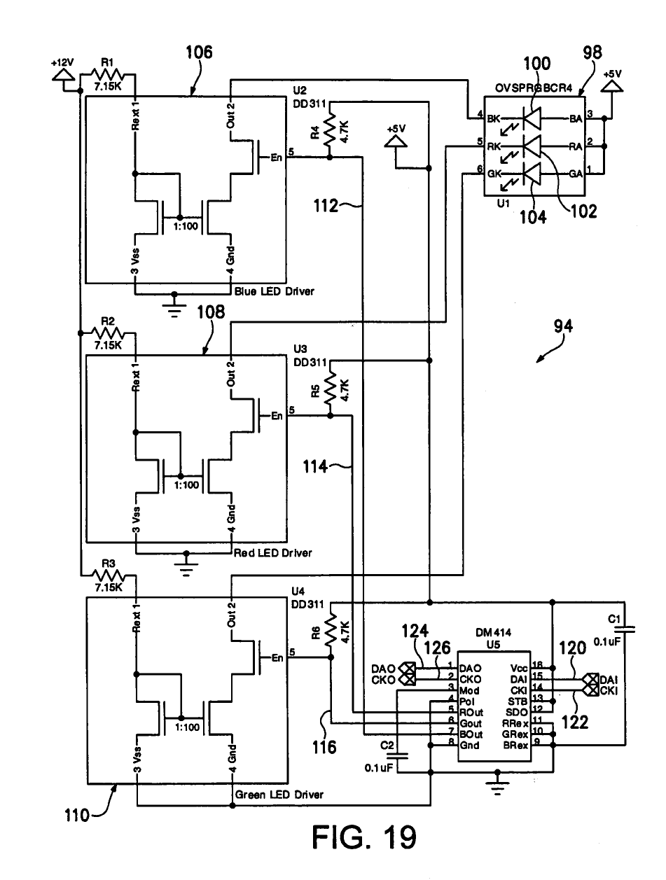

For a more detailed schematic of each of the light modules, attention is directed to FIG. 19, which depicts light module 94. Light module 94 is substantially identical to each of the other light modules. Included therein is a tri-color LED chip 98. Chip 98 includes a blue LED 100, a red LED 102, and a green LED 104. Each LED has its anode tied to +5 volts, and each cathode is driven with a separate dedicated LED driver 106, 108, 110, respectively. Each driver includes an enable line 112, 114, 116, respectively. The enable lines are driven by a chip 118 in response to data provided to the chip via data-in (DAI) terminal 120 and clock (CLK) terminal 122. The data in chip 118 may be shifted out to the next light module 95 in FIG. 18 via data-out (DAO) terminal 122 and clock (CLK) terminal 126.

The data that is transferred into each light module, like light module 94, via DAI and CLK terminals, like DAI terminal 120 and CLK terminal 122 comprises 24 bits of data, 8 bits associated with each color. Each 8 bits modulates a pulse with signal on their associated enable line, like the blue enable line 112. As a result, each color can be selected with an intensity of between 0 and 255, with 0 being off and 255 being the most intense illumination possible.

Each of tri-color LED chips is positioned at the base of a corresponding one of the rods, like rods 46, 48, in light bank 49. In the present embodiment, the rods are made from Plexiglas polymer, which conducts light into a light channel surrounded with a frosted edge. The result is a rod that glows with selected colors and intensities.

In operation, a number of pre-programmed lighting modes are stored in a memory associated with PIC microprocessor 78. These include:
PURE_SWEEP—sets all 27 rods to the same color.
GRAY—fills all rods with gray that starts at the center rod and sweeps toward the outer rods on each side in a little over a second.
REDFILL—fills all rods with blue starting at the outer rods and sweeping toward the center in a little over a second.
RANBOW_ANIM—starts with the rods set to different colors and rotates the colors from left to right.
BLUETORED—processor 68 provides a single byte with a value of 0-255 to PIC microprocessor 78, which determines the percentage of rods starting from the outside and moving toward the center) that are red. The rest of the rods are blue except for the one between the transition from red to blue, which is a combination of blue and red.

The value of the byte provided in the BLUETORED mode is related to the likelihood of initiating the secondary game. As described above this could be an indication of the how close the count is to the random trigger value, to the upper end of the range from which the random trigger value is chosen, or to a combination of the two. In addition to driving the rods, signals from light display controller 76 also control the display of meter 50 and the display of rod images 52. As a result, coordinated graphical representations of win proximity are provided in a variety of ways.

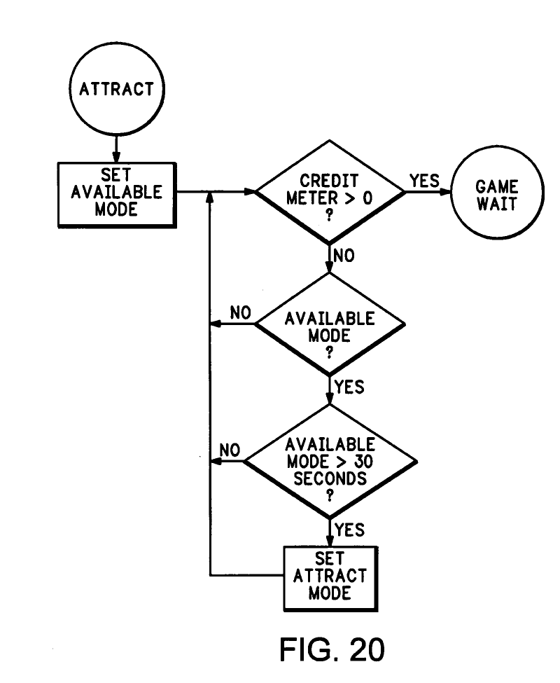

Turning now to FIGS. 20-22, consideration will be given to examples of various lighting modes during game play. In FIG. 20, when the credit meter first goes to zero, either as a result of the player cashing out or wagering his or her last credit, the lighting mode is set to Available mode for 30 seconds. In this example, available mode comprises RANBOW_ANIM, described above.

In the event that no further credits are wagered during Available mode, the lighting mode is set to Attract mode (PURE_SWEEP) until additional credits are wagered.

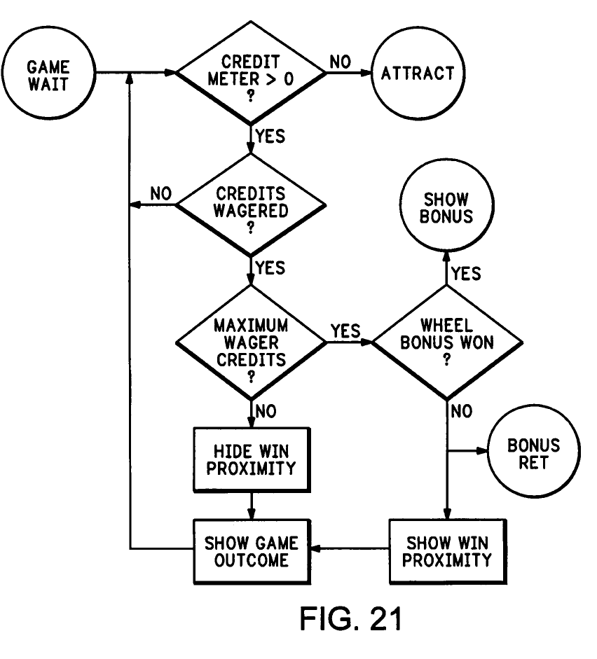

FIG. 21, describes lighting behavior during normal game play, i.e., when there are credits on the credit meter. For every wager less than 3 credits, or when dictated by rules set within the eligibility engine, the proximity meter is hidden or deactivated as by setting the lighting mode to GRAY and setting meter 50 and rod images 52 as shown in FIG. 16. When 3 credits, maximum in this example, are wagered, and/or when dictated by the eligibility engine, the lighting mode is set to BLUETORED, and win proximity is displayed, e.g., as shown in FIGS. 12-15. As previously mentioned, the game could be implemented to always show win proximity, even in the presence of a 2 or 3 credit bet, i.e., less than the maximum. Exemplary eligibility set forth in the eligibility engine may conform to Table 1, shown below.

TABLE 1
Win Proximity Meter Manipulation

| | Tracked Value | Determined Play | Defined | |
|---|---|---|---|---|
| Play Tracked | (TV) | Value (DPV) | Relationship | Result |
| Max credits | 1-2 | 3 (max) | TV = DPV | Relationship fails. Win proximity |
| played? | | | | indicator deactivated as per FIG. 16. |
| Max credits | 3 | ″ | ″ | Relationship satisfied. Win proximity |
| played? | | | | indicator activated per FIGS. 12-15. |
| Credits | 0 | 1 | TV ≧ DPV | Relationship fails. Win proximity |
| remaining | | | | indicator deactivated as per FIG. 16. |
| Player Status | Diamond | Gold | TV ≧ DPV | Relationship satisfied. Win proximity |
| | | | | indicator activated per FIGS. 12-15. |
| Special | Plays machine | Dec. 23-26, Early | TV = DPV | Relationship fails. Win proximity |
| Promotion: | on Dec. 23, | bird times 8 am- | | indicator deactivated as per FIG. 16. |
| Time/Date | 10 pm | 2 pm | | |
| Minimum Play | 10 credits per | 8 credits per | TV ≧ DPV | Relationship satisfied. Win proximity |
| rate | minute | minute | | indicator activated per FIGS. 12-15. |
| Elapsed time | 90 seconds | 60 seconds | TV ≦ DPV | Relationship fails. Win proximity |
| between wagers | | | | indicator deactivated as per FIG. 16. |

As noted above, the game includes an eligibility engine that is configured to track play on the base game and trigger display of the proximity indicator only when play bears a defined relationship to a first determined play value. Display of the proximity indicator may thus be an incentive for a player to meet certain play value, whether tied to rate of play, play of a max coin bet, etc. Display of the win proximity meter may be tied to satisfaction of any one of particular relationships. For instance, if max credit, credits remaining, and player status are all in OR relationship within the eligibility engine, then a Diamond player may be allowed to see the proximity meter even though he or she did not play max credits. Similarly, the eligibility engine can be based on an AND relationship between multiple eligibilities so that all must be satisfied in order for the proximity meter(s) to be displayed.

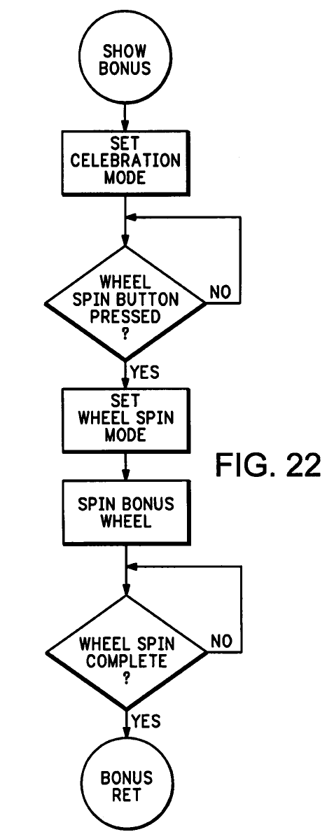

Returning back to FIG. 21 concerning the max bet criterion as being the sole eligibility relationship tracked, after each maximum bet, the process depicted in FIG. 21 checks to see if the count equals the random trigger. If so, the player is given the opportunity to play the secondary game, and the process depicted in FIG. 22 is implemented.

In celebration mode, the game is programmed with celebratory audio and lighting effects. It waits for the player to press the maximum credit button, which initiates the wheel spin in this mode. Alternatively, the game could be programmed to wait a predetermined length of time for the player to press the button and then automatically enter wheel spin mode if the button has not been pressed by when the predetermined time lapsed.

Either way, wheel spin mode is entered when processor 68 instructs wheel controller 74 to spin the wheel. When the wheel spin is complete, the credits won by the player, which are indicated on the wheel segment aligned with pointer 44, are applied to the credit meter, and the process of FIG. 22 transfers control back to the process of FIG. 21. Once all the credits are off the credit meter, the process of FIG. 21 transfers control to the process of FIG. 20.

I have described above specific implementations of the invention only as examples of how implementation may be accomplished. It will be clear to one of skill in the art that the invention may be embodied in the manner described or in a range of other expressions.

What is claimed is:

1. A gaming device comprising:
a bonus game;
a number generator configured to select multiple trigger thresholds over time, including a present trigger threshold and at least one past trigger threshold;
at least one bonus award mechanism configured to award a bonus award;
at least one counter configured to generate a count related to the occurrence of wagers that bear a defined relationship to a determined value, the counter being operatively connected to the bonus award mechanism and configured to award a bonus award when the count bears a predetermined relationship to the present trigger threshold; and
a display configured to provide a graphical indication of the change in likelihood of awarding the bonus award and provide a graphical indication of the relationship of the past trigger threshold to the change in likelihood of awarding the bonus award.

2. The gaming device of claim 1, wherein the display is further configured to provide a graphical indication of the relationship of a second past trigger threshold to the change in likelihood of awarding the bonus award.

3. The gaming device of claim 1 wherein the display is configured to provide the graphical indication of the change in likelihood of awarding the bonus award only when a wager bears the defined relationship to the determined value.

4. The gaming device of claim 1 wherein the trigger threshold is less than or equal to a predetermined number and wherein the display comprises an indication of the proximity of the count to the predetermined number.

5. The gaming device of claim 1 wherein the display comprises an indication of the proximity of the count to the trigger threshold.

6. The gaming device of claim 1 wherein wagers that bear the defined relationship to the determined value comprises a wager that is greater than a predetermined value.

7. The gaming device of claim 6 wherein the wager that is greater than a predetermined value comprises the maximum credit that can be wagered.

8. The gaming device of claim 1 wherein the gaming device further includes:
means for selecting a second trigger threshold;
a second bonus award mechanism configured to award a second bonus award in addition to any award resulting from the base game pay table; and
a second counter configured to generate a count related to the occurrence of wagers that bear a second defined relationship to a second determined value, the second counter being operatively connected to the second bonus award mechanism and configured to award a second bonus award when the second count bears a predetermined relationship to the second trigger threshold.

9. The gaming device of claim 8, wherein the display is configured to provide a graphical indication of the change in likelihood of awarding the bonus award associated with the count that is closest to its trigger threshold.

10. A gaming device comprising:
a base game;
a base game pay table;
at least one bonus award mechanism configured to award a bonus award in addition to any award resulting from the base game pay table;
a first win proximity indicator configured to provide an indication of the change in likelihood of awarding the bonus award; and
a display configured to provide a first indicia of a previous win of the bonus award together with the first win proximity indicator.

11. The gaming device of claim 10, the display further being configured to display a second indicia of a previous win, said second indicia associated with a bonus award further back in time that said first indicia.

12. The gaming device of claim 10, the display further being configured to display a meter, wherein the first indicia of the previous win is shown on the meter in spatial relationship to the first win proximity indicator.

13. The gaming device of claim 12, the meter further including an elongate portion encompassing a range of trigger thresholds of the bonus award, the first win proximity indicator being a moving pointer displayed along the elongate portion and the first indicia being a static pointer displayed along the elongate portion.

14. The gaming device of claim 13, wherein the meter further includes a second indicia of a second previous win displayed along the elongate portion in spatial relationship with the first indicia.

15. A method of operating a gaming device comprising:
selecting at least two trigger thresholds including a first past trigger threshold and a current trigger threshold;
generating at least one count related to the occurrence of wagers;
comparing the count and the current trigger threshold;
indicating the proximity of the count to the current trigger threshold and to the first past trigger threshold; and
awarding a bonus award when the count substantially meets the current trigger threshold.

16. The method of claim 15, further including:
responsive to awarding the bonus award, converting the current trigger threshold to a new first past trigger threshold;
selecting a new current threshold trigger;
generating a new count related to the occurrence of wagers; and
indicating the proximity of the new count to the new current trigger threshold and to the new first past trigger threshold.

17. The method of claim 16, further including:
responsive to awarding the bonus award, converting the first past trigger threshold to a new second past trigger threshold; and
indicating the proximity of the new count to the new second past trigger threshold.

18. The method of claim 15, wherein the step of indicating the proximity of the count to the current trigger threshold includes displaying a moveable indicator along a range of possible trigger amounts.

19. The method of claim 18, wherein the step of indicating the count to the first past trigger threshold includes displaying a static indicator along the range of possible trigger amounts.

20. The method of claim 18, further including displaying a second static indicator along the range of possible trigger amounts to indicate a second past trigger threshold.

21. The method of claim 20, further including distinguishing the static indicator from the second static indicator.

22. The method of claim 21, wherein the step of distinguishing the static indicator from the second static indicator includes displaying the static indicator with a larger size than the second static indicator.
